(19) United States
(12) Patent Application Publication
(10) Pub. No.: US 2017/0031401 A1
(43) Pub. Date: Feb. 2, 2017

(54) POWER SWITCH SYSYEM AND ELECTRONIC DEVICE USING THE SAME

(71) Applicant: HON HAI PRECISION INDUSTRY CO., LTD., New Taipei (TW)

(72) Inventor: CHIH-CHANG CHANG, Tu-Cheng (TW)

(21) Appl. No.: 14/812,779

(22) Filed: Jul. 29, 2015

(51) Int. Cl. G06F 1/26

(52) U.S. Cl. CPC G06F 1/263

(57) ABSTRACT

A power switch system applied in an electronic device includes a plurality of power sources, a plurality of switch units, and a motherboard. The motherboard includes a controller and an output which is coupled to a load. Each switch unit is coupled to one corresponding power source, the controller, and the output of the motherboard. The controller can detect and select a power source from amongst the plurality of power sources, and output a control signal to one corresponding switch unit coupled to the selected power source, to control the selected power source supply power to the load through the corresponding switch unit. If one of the switch units or the corresponding power supply cannot operate normally, other switch unit from amongst the switch units can execute to operate and transmit power from a corresponding power source to the load.

### FIELD

The subject matter herein generally relates to an electronic device and particular to a power switch system thereon.

### BACKGROUND

A power switch is coupled to a power source, and is configured to transmit power from the power source to a load. However, when the power switch or the power source at failure, the load cannot receive power to operate normally.

### BRIEF DESCRIPTION OF THE DRAWINGS

Implementations of the present technology will now be described, by way of example only, with reference to the attached figures.

FIG. 1 is a block diagram of an embodiment of an electronic device coupled to at least one load, wherein the electronic device comprises a power switch system and a plurality of power sources.

FIG. 2 is a block diagram of a first embodiment of the power switch system of FIG. 1.

FIG. 3 is a block diagram of a second embodiment of the power switch system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently coupled or releasably coupled. The term “comprising,” when utilized, means “including, but not necessarily limited to”; it specifically indicates open-ended inclusion or membership in the so-described combination, group, series and the like.

The disclosure will now be described in relation to an electronic device with a power switch system.

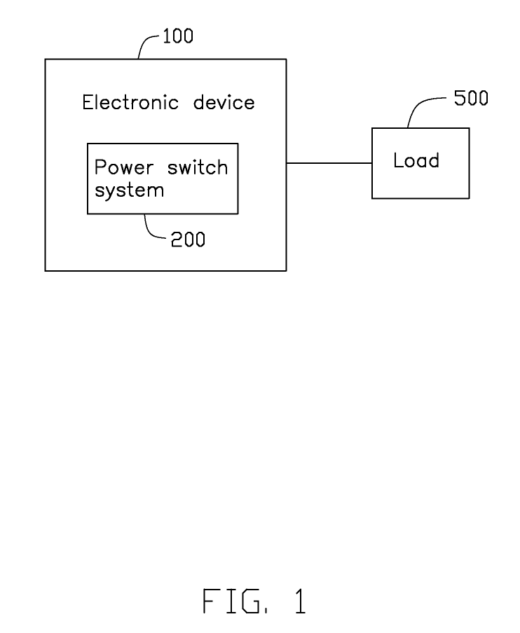

FIG. 1 illustrates a block diagram of an electronic device 100 comprising a power switch system 200. In the embodiment, the electronic device 100 can be a server, and is coupled to at least one load 500.

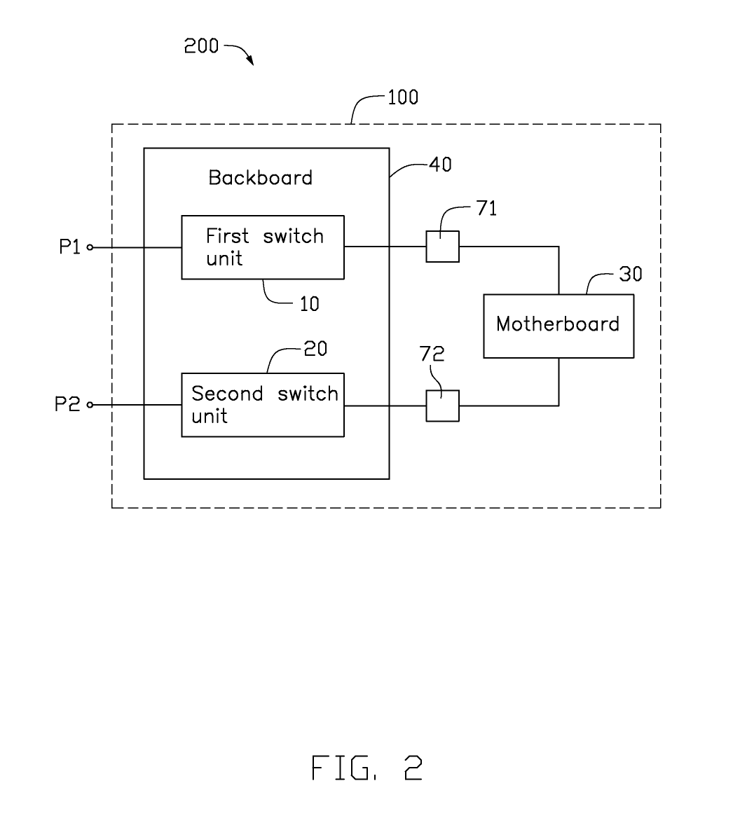

FIG. 2 is a block diagram of a first embodiment of the power switch system 200 comprising a first switch unit 10, a second switch unit 20, and a motherboard 30. The first switch unit 10 is configured to couple to a first power source P1 and the motherboard 30. The second switch unit 20 is configured to couple to a second power source P2 and the motherboard 30. In the embodiment, the first and second switch units 10, 20 can be positioned on a backboard 40.

In the embodiment, the motherboard 30 can couple to the first switch unit 10 and the second switch unit 20 respectively through two connectors 71, 72. The motherboard 30 can supply power to the load 500, selectively from the first power source P1 through the first switch unit 10 or the second power source P2 through the second switch unit 20.

The motherboard 30 can comprise a controller 301 and an output 302 thereon. The first switch unit 10 can comprise a relay 101, a silicon controlled rectifier (SCR) 103, and a power source unit (PSU) 105. The second switch unit 20 can comprise a relay 202, a SCR 204, and a PSU 206. The relay 101 is coupled to the first power source P1, a first terminal of the SCR 103, and the PSU 105. The PSU 105 is configured to couple to the first power source P1. A second terminal of the SCR 103 is coupled to the output 302 of the motherboard 30. The controller 301 of the motherboard 30 is coupled to the relay 101, a control terminal of the SCR 103, and the PSU 105 through the connector 71. The relay 202 is coupled to the second power source P2, the SCR 204, and the PSU 206. The PSU 206 is configured to couple to the second power source P2. The SCR 204 is coupled to the output 302 of the motherboard 30. The controller 301 of the motherboard 30 is coupled to the relay 202, the SCR 204, and the PSU 206 through the connector 72. The output 302 is coupled to the first switch unit 10 and the second switch unit 20, and is configured to transmit power from the first power source P1 or the second power source P2 to the load 500. In the embodiment, the PSU 105 and the PSU 206 are auxiliary power supply.

In use, if the first power source P1 is selected and detected by the controller 301 to operate normally, the controller 301 outputs a first control signal to the relay 101 and the SCR 103. The relay 101 and the SCR 103 are turned on. Therefore, the first power source P1 can supply power to the output 302 through the relay 101 and the SCR 103. The output 302 can transmit the power to the load 500. If either of the first power source P1 or the first switch unit 10 operates abnormally, the controller 301 can receive power from the PSU 206 of the second switch unit 20, and can output a second control signal to the relay 202 and the SCR 204. The relay 202 and the SCR 204 are turned on. Therefore, the second power source P2 can supply power to the output 302 through the relay 202 and the SCR 204. The output 302 can transmit the power to the load 500. The first power source unit 10 can be repaired at the same time, without prejudice to the operation of the second power source P2 supplying power to the load 500 through the second switch unit 20.

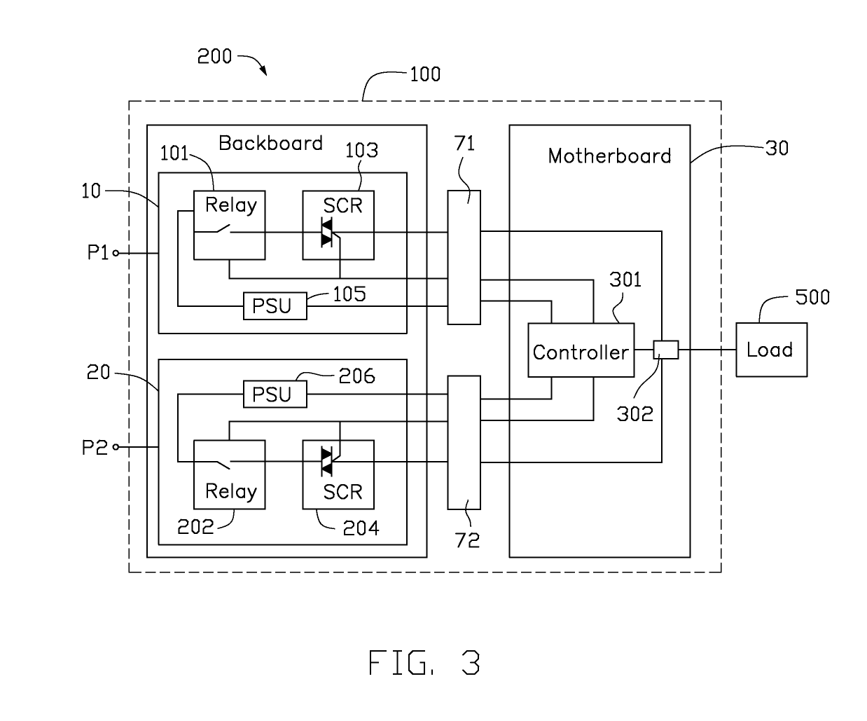

FIG. 3 is a block diagram of a second embodiment of the power switch system 300. The power switch system 300 can comprise a plurality of switch units 310, a motherboard 330, and a plurality of power sources P3. Structure and connection of each one of the switch unit 310 of the power switch system 300 are the same as those of each one of the first and second switch units 10, 20 of the power switch system 200. One switch unit 310 from amongst the plurality of switch units 310 is correspondingly coupled to one power source P3 from amongst the plurality of power sources P3. Connection an principle between each switch unit 310, the corresponding power source, and the motherboard 330 are the same as that of each switch unit of the power switch system 200, the corresponding power source, and the motherboard 30. Therefore, if one of the switch units 310 or the corresponding power supply cannot operate normally, other switch unit from amongst the switch units 310 can execute to operate and transmit power from a corresponding power source to the load 500. Therefore, the power switch system 200 can be conveniently used in the condition of hot swapping and redundant.

While the disclosure has been described by way of example and in terms of the embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A power switch system comprising:
a motherboard comprising a controller and an output, wherein the output is configured to be coupled to a load;
a plurality of power sources; and
a plurality of switch units coupled to the motherboard and the power sources, wherein a switch unit from amongst the plurality of switch units is coupled with a power source from amongst the plurality of power sources, and is coupled with the controller and output of the motherboard, the controller can detect and select a power source from amongst the plurality of power sources, and output a control signal to one corresponding switch unit coupled to the selected power source, to control the selected power source supply power to the load through the corresponding switch unit.

2. The power switch system of claim 1, wherein each one of the switch units comprises a relay, a silicon controlled rectifier (SCR) coupled to the relay and the output of the motherboard, and a power source unit (PSU) coupled to the relay; the relay and the PSU of each switch unit from amongst the plurality of switch units are coupled to the selected power source; the controller of the motherboard is coupled to each relay, SCR, and PSU, and is configured to output a control signal to the relay and the SCR of the corresponding switch unit coupled to the selected power source, to control the relay and the SCR are turned on, which can make the power source to supply power to the load through the selected switch unit and the output of the motherboard.

3. The power switch system of claim 2, wherein a first terminal of the SCR is coupled to the relay of each switch unit, a second terminal of the SCR is coupled to the output of the motherboard, a control terminal of the SCR is coupled to the controller of the motherboard.

4. The power switch system of claim 3, wherein the plurality of switch units are positioned on a backboard.

5. The power switch system of claim 1, further comprising a plurality of connectors, wherein each switch unit is coupled to the motherboard through a corresponding connector.

6. An electronic device comprising a power switch system, power switch system comprising:
a motherboard comprising a controller and an output, wherein the output is configured to be coupled to a load;
a plurality of power sources; and
a plurality of switch units coupled to the motherboard and the power sources, wherein a switch unit from amongst the plurality of switch units is coupled to a power source from amongst the plurality of power sources, and is coupled to the controller and output of the motherboard, the controller can detect and select a power source from amongst the plurality of power sources, and output a control signal to one corresponding switch unit coupled to the selected power source, to control the selected power source supply power to the load through the corresponding switch unit.

7. The electronic device of claim 6, wherein each one of the switch units comprises a relay, a silicon controlled rectifier (SCR) coupled to the relay and the output of the motherboard, and a power source unit (PSU) coupled to the relay; the relay and the PSU of each switch unit from amongst the plurality of switch units are coupled to the selected power source; the controller of the motherboard is coupled to each relay, SCR, and PSU, and is configured to output a control signal to the relay and the SCR of the corresponding switch unit coupled to the selected power source, to control the relay and the SCR are turned on, which can make the power source to supply power to the load through the selected switch unit and the output of the motherboard.

8. The electronic device of claim 7, wherein a first terminal of the SCR is coupled to the relay of each switch unit, a second terminal of the SCR is coupled to the output of the motherboard, a control terminal of the SCR is coupled to the controller of the motherboard.

9. The electronic device of claim 8, wherein the plurality of switch units are positioned on a backboard.

10. The electronic device of claim 6, further comprising a plurality of connectors, wherein each switch unit is coupled to the motherboard through a corresponding connector.
